(19) United States
(12) Patent Application Publication
(10) Pub. No.: US 2002/0154023 A1
(43) Pub. Date: Oct. 24, 2002

(54) Bolt tamper sensor

(76) Inventor: Jacob Hazan, Petah Tikva (IL)

Correspondence Address: SHIBOLETH YISRAELI ROBERTS & ZISMAN, LLP, 350 FIFTH AVENUE, 60TH FLOOR, NEW YORK, NY, 10118

(21) Appl. No.: 09/922,200

(22) Filed: Oct. 31, 2001

Related U.S. Application Data
(60) Provisional application No. 60/222,767, filed on Aug. 3, 2000.

(51) Int. Cl. G08B 21/00

(52) U.S. Cl. 340/687; 340/686.1; 340/693.5; 200/61.39; 200/236; 200/247

(57) ABSTRACT

An electromechanical sensor for use with an alarm system, comprises a housing containing upper and lower conductive components, for example flanged washers. The upper and lower conductive components are elastically separated and are compressibly displaceable from a first closed circuit position to a second open circuit position by the installation and tightening of a bolt through the sensor. The upper and lower conductive components are electrically isolated from the housing by at least one non-conducting sleeve when the conductive components are compressed into the second open circuit position by the bolt tightening. At least one of the upper and lower conductive components comes into conductive contact with the housing when the bolt is withdrawn, compression reduced and the conductive components are allowed to expand into the first closed circuit position.

### CROSS-REFERENCE TO RELATED APPLICATIONS

The present application claims the priority date of U.S. Provisional Application 60/222,767, filed Aug. 3, 2000, in accordance with 35 USC §119(e).

### FIELD OF THE INVENTION

The present invention relates generally to sensors for use in security systems. More particularly, the sensors of the present invention relate to sensors for detecting tampering with bolts of the kind used in industrial and heavy equipment environments.

### BACKGROUND OF THE INVENTION

There is a need for assuring the security of heavy construction equipment. For example, it is desirable to bolt down the hood of a bulldozer, so that if left overnight, and not otherwise secured, the hood cannot be easily raised in order to steal expensive parts. Attempts have been made in the past to provide apparatus for detecting tampering with bolts but the known methods have not proven equal to the task of either [1] delaying the thiefs access to the target until help arrives; [2] resisting attempts of would-be thieves to bypass the tamper sensor and thereby prevent an alarm from being given; or [3] both of these objectives.

An example of a prior art device is disclosed in U.S. Pat. No. 4,713,506 to Klink. The disclosure teaches a device for detecting when a screw is withdrawn from its place between electrical contacts. However, the article protected by such a device would not be secure from an attacker who removes the head of the screw while leaving the body of the screw intact within the monitoring circuit. In the case of heavy equipment, all of the screws could be thus disabled with no alarm being raised until all the screws had been disabled and only when the truck hood is lifted, or the generator lifted onto the thieves' trucks would the alarm begin to sound. The thieves would have maximum getaway time.

Another example of the prior art devices is disclosed in U.S. Pat. No. 4,329,681 however the disclosed sensor would not withstand a brute force attack by which the sensor with bolt head encased therein is simply pried over and snapped off or sawn off. Alternatively, a drill could be applied through the casing and bolt head. In any case, a resourceful thief that merely wants maximum getaway time can easily bypass such a defense and when the stakes are high enough, they usually do succeed. Moreover, since the circuit is protecting the bolt but not vice versa, and thus is exposed, it may possible to tap into and electronically fool the circuitry into failing to detect a change in resistance, thereby bypassing the alarm circuitry and successfully removing all bolts without the alarm being activated until it is too late.

### SUMMARY OF THE PRESENT INVENTION

Thus the present invention seeks to provide a mechanism whereby equipment in general and heavy equipment in particular are protected using tamper sensors through which heavy bolts are passed through. The bolts actually hold the spring-loaded, expandible sensor in place. Because the sensor has two potential contacts which are shielded by the sensor housing as well as the bolt above and the secured article below, any attempt to shift the sensor housing or the bolt head relative to one another or the secured article, results in closing of the circuit and the alarm being raised. In fact, in a situation where the secured article is so large that lifting of the article is not expected, and the sensors can be placed between the large article and the mounting surface upon which it will rest, then bolts may not be necessary. However, it is also recognized that in such a scenario, any prospective thieves simply need to complete the loading process and drive away before security forces arrive. Ideally, a large plurality of the inventive combination of bolts and sensors are used so that significant effort, and therefore time, are consumed in breaking through all of them before beginning the getaway.

This is accomplished by providing an electromechanical sensor body which comprises a conductive housing within which are disposed upper and lower conductive components. The upper and lower conductive components are separated from one another elastically by a conductive compressible element and are compressibly displaceable from a first closed circuit position to a second open circuit position. The upper and lower conductive components are electrically isolated from the conductive housing by at least one electrically non-conductive sleeve when conductive components are compressed into the second open circuit position. At least one of the upper and lower conductive components must come into conductive contact with the housing, possibly by direct contact with a contact surface thereon, when at least one of the conductive components is in the first closed circuit position.

### BRIEF DESCRIPTION OF THE DRAWINGS

In order to understand the invention and to see how it may be carried out in practice, an exemplary embodiment will now be described, by way of non-limiting example only, with reference to the accompanying drawings, in which:

FIG. 1 is a partial cross-sectional view of a bolt tamper sensor installation, wherein the bolt is fully tightened into place, in accordance with an exemplary embodiment of the present invention;

FIG. 2 is a partial cross-sectional view of a bolt tamper sensor installation, wherein the bolt is partially screwed into place, but not tightened, in accordance with an exemplary embodiment of the present invention; and

FIG. 3 is a partial cross-sectional view of a bolt tamper sensor installation, wherein the bolt is substantially not screwed into place, in accordance with an exemplary embodiment of the present invention; and

FIG. 4 is a schematic illustration of a comparator circuit, in accordance with an exemplary embodiment of the present invention.

### DETAILED DESCRIPTION OF EXEMPLARY EMBODIMENTS

The sensor of the present invention is specifically designed for securing important parts, such as electric motors, pumps, hydraulic components, air hammers, generators, etch, against loosening and/or unauthorized opening. The sensor is installed by simply inserting the bolt, whose security is to be assured, through the sensor, and tightening the bolt in place.

The sensor is intended to give instant warning and can be adapted to trigger an alarm system.

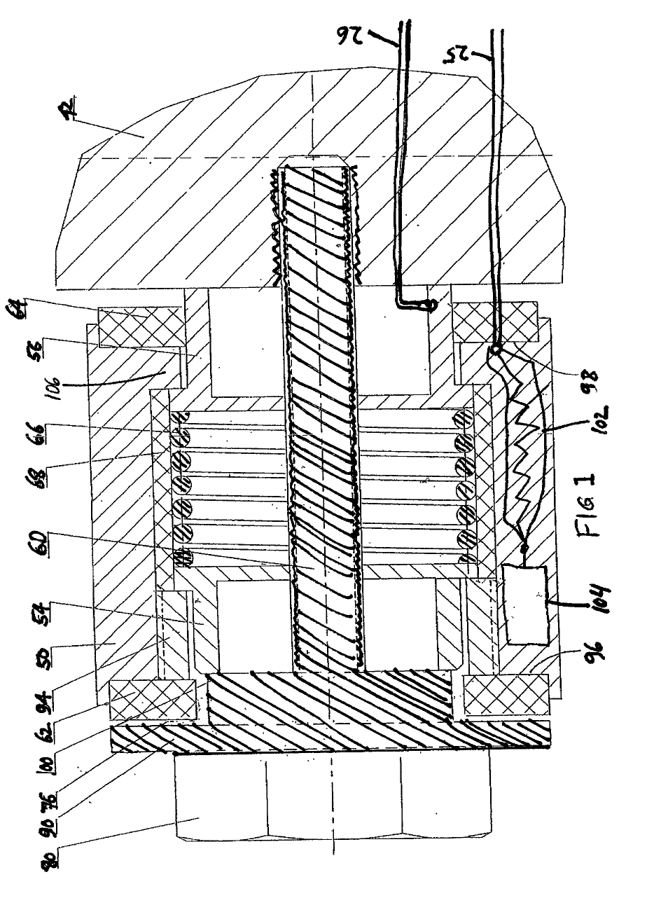

FIGS. 1 through 3 illustrate the electromechanical features of the installation of bolt 80 and sensor 22.

Sensor 22 may be manufactured in practically and size and cross-sectional shape. Each sensor 22 can be provided in a range of sizes corresponding to a range of several bolt sizes.

Sensor 22 protects bolt 80 by triggering an alarm if the sensor is tampered with in any one of the following ways, for example:

against unauthorized opening;

against loosening;

against loosening even if the complete sensor 22 is held against the head of bolt 80 as the bolt 80 is withdrawn or against secured article 42 in which bolt 80 is installed; and

against shorting or disconnecting of any of the wires 25 or 26 of sensor 22 (“hotwires”).

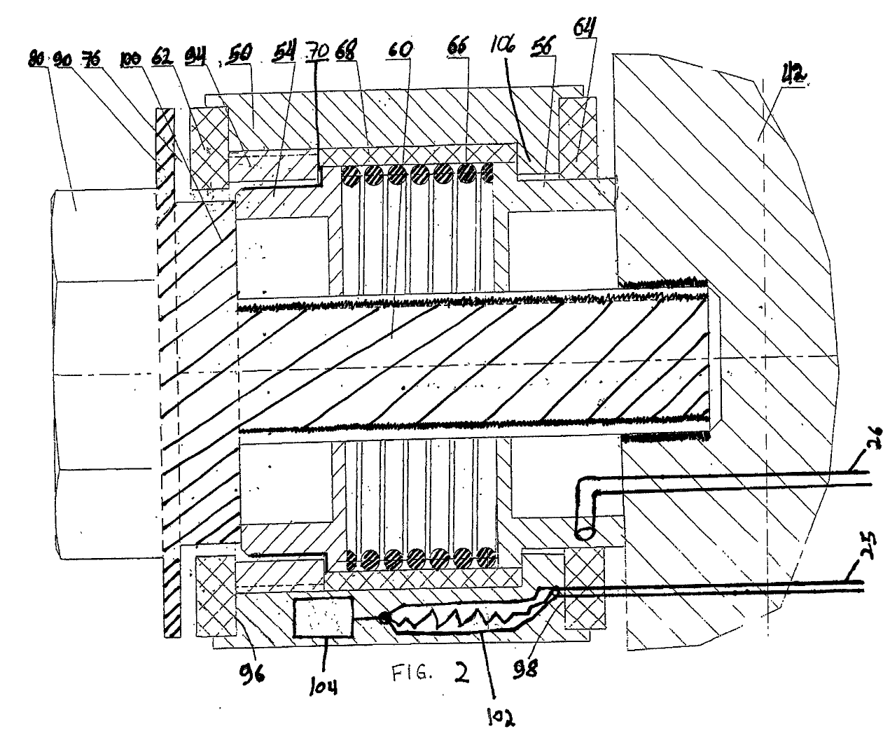

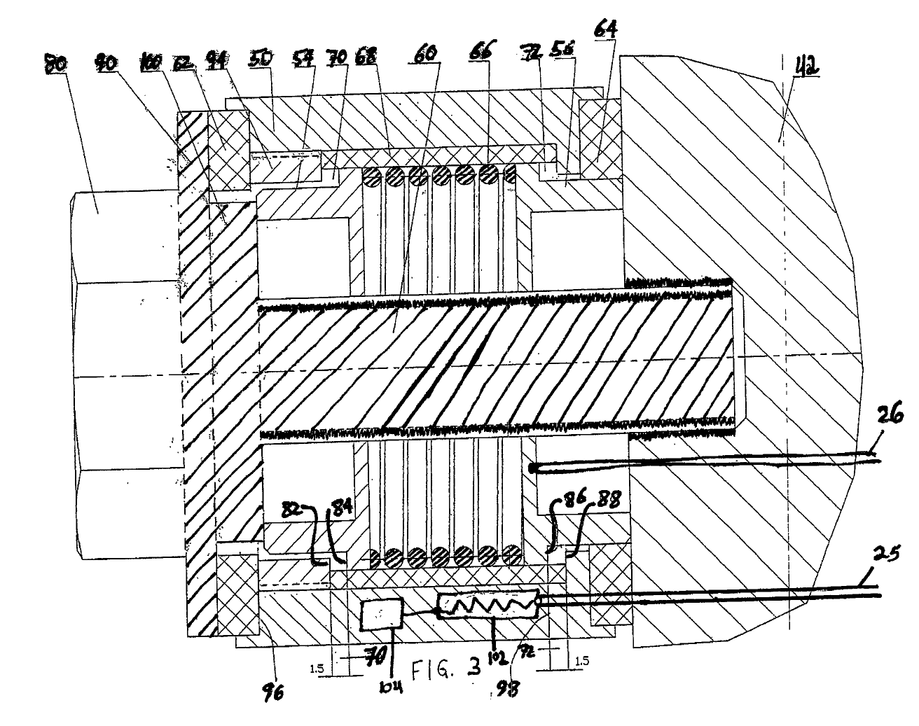

FIG. 1 is a partial cross-sectional view, of bolt tamper sensor 22 installation, wherein bolt 80 is fully tightened into place, in accordance with an exemplary embodiment of the present invention. In FIG. 1, gap 76 is closed and does not appear, in contrast to FIG. 2 and FIG. 3 where gap 76 is substantial. However, gaps 70 and 72 form, and create an open circuit.

FIG. 2 is a partial cross-sectional view, of bolt tamper sensor 22 installation, wherein bolt 80 is partially screwed into place, but not tightened, in accordance with an exemplary embodiment of the present invention. In FIG. 2, gap 76 between bolt head washer 90 and washer 62 is partially closed.

FIG. 3 is a partial cross-sectional view, of bolt tamper sensor 22 installed, wherein bolt 80 is not fully screwed into place, in accordance with an exemplary embodiment of the present invention. FIG. 3 shows a gap 76 between bolt head washer 90 and insulating washer 62.

Bolt 80 passes through a sensor housing 50, tightening together other mechanical parts of sensor 22, as well as the secured article 42 into which bolt 80 is screwed, as described hereinbelow. Bolt 80 is electrically insulated from sensor 22 and does not form part of the comparator circuit.

The functional requirements of sensor 22 may in an exemplary embodiment be provided by embodiments or alternatives to the following electromechanical components:

sensor housing 50, which may be composed of metal or some electrically conductive rigid material and has a known resistance, has connected thereto or embedded therein, a resistor 102, both of which are in a constant state of short circuit, via lead 25 as a part of a comparator circuit 20. The remainder of the comparator circuit 20 may be located at a distance from the sensor 22, or it may be provided as an IC (integrated circuit) within a microchip located within a chamber 104 inside the wall of sensor housing 50. Lead 26, shown connected to flanged washer 56 could just as well be connected to flange washer 54 or spring 66. Furthermore, as an alternative embodiment, there could be located in chamber 104 a small power source and a transmitter for sending detected changes in the overall circuit resistance to a central monitoring station and to initiate alarm activation;

upward facing flanged metal washer 54 and downward facing flanged washer 56, both of which move inside sensor housing 50 and are separated by a conductive compressible element, such as spring 66. An “armed” state is initiated when flanged washers 54 and 56 are compressed by bolt 80, thereby opening the circuit by disconnecting them from sensor housing 50;

insulating washers 62 and 64 which may be fabricated from Delrin or TEFE, for example, respectively insulate the head of bolt 80 from sensor housing 50, and sensor housing 50 from any metal parts which may also be in contact with the bolt stem 60. Set against the head of bolt 80, they have the following functions:

a) to maintain flanged washers 54 and 56 inside sensor housing 50 yet allowing no electrical contact when bolt 80 is screwed in, and by being screwed in, thereby pressing together the parts of sensor 22;

b) to allow adaptation of sensor housing 50 to the size of bolt 80, permitting the size to be adjusted by simple drilling;

insulating sleeve 68 which may be fabricated from Delrin or TEFE, for example, provides the following:

a) insulates the conductive compressible element, spring 66 from sensor housing 50;

b) allows movement of flanged washers 54 and 56 within it; and

c) insulates sensor housing 50 from flanged washers 54 and 56 when bolt 80 is screwed in fully.

Washer 100, which is preferably integrally formed with or securely attached to the head of bolt 80 together with bolt head washer 90 and bolt stem 60 is provided to prevent tampering with flanged washer 54 by attempting to force a screwdriver or some other object in from the side. Additionally, washer 100, which is sized to fit within insulating washer 62, is in actual contact with flanged washer 54 and presses thereagainst up to the depth permitted by compression of bolt head washer 90 against insulating washer 62; and

cylindrical washer 94, which not only maintains sleeve 68 in place, it also serves as a potential contact point to conduct current between flanged washer 54 and sensor housing 50. Instead of being a separate component, housing 50 could be shaped to have a cross-sectional profile resembling double brackets, i.e., [ ] such that an insulator layer could be provided on its inner surface between spring 66 and housing 50. For example if one first formed a flange 106 in the bottom of a cylinder intended to form a housing 50, coated the inner surface of the wall portion with an insulator coating, then inserted a downward facing flanged washer 56, followed by a spring 66 and then the upward facing flanged washer 54 and then bent in and over the top edge of the cylinder to form a flange at the top, one could form a self-contained unit combining the aforementioned components.

In one alternative embodiment of the present invention, an RF (radio frequency) transmitter is located in sensor housing 50 and a battery can be located adjacent thereto or in flanged washer 54 (among other possible locations).

With particular reference to FIG. 3, bolt 80 and sensor 22 are assembled as follows. Insulating sleeve 68 is inserted into sensor housing 50. Downward facing flanged washer 56 is then inserted and insulating washer 64 is applied to the bottom annular groove 98 between sensor housing 50 and washer 56. Insulating washer 64 is provided with a minimum thickness such that it barely electrically isolates sensor housing 50 from contact with secured article 42. The distance between the bottom of sensor housing 50 from secured article 42 should be as small as possible, such that it would be difficult to drill through or cut away from insulating washer 64 without grounding sensor housing 50 by contact with either the drill bit or saw, for example. Spring 66 is inserted followed by upward facing flanged washer 54. Cylindrical washer 94 is then inserted and screwed into place to slightly compress flanged washers 54 and 56 together with spring 66. Insulating washer 62 is applied into annular groove 96 and bolt 80 is now screwed into place.

With particular reference to FIGS. 1 2 and 3, operation of sensor 22 when bolt 80 is installed and tightened:

when bolt 80 passes through sensor 22, and is tightened, all the parts of sensor 22 are pressed together;

a conductive compressible element, in the exemplary embodiment, a spring 66 is compressed between flanged washers 54 and 56 as they slide inside sleeve 68, thereby creating gaps 70 and 72 between washer flange contact points 84 or 86 with housing contact points 82 and 88, thereby isolating sensor housing 50 from flanged washers 54 and 56 as well as spring 66. In the state aforementioned the sensor housing 50 forms a part of comparator circuit 20 with a constant resistance of value R;

bolt 80 is insulated from sensor housing 50 by insulating washers 62 and 64 and provides constant contact between flanged washers 54 and 56, spring 66, and secured article 42 into which bolt 80 is screwed; and

any attempt to loosen or remove bolt 80 from its place, shorting or disconnecting any wire in comparator circuit 20, causes imbalance in circuit 20 and triggering of alarm 36.

The operation of sensor 22 when bolt 80 is loosened proceeds as follows:

sensor housing 50 moves along the outside of sleeve 68 and is insulated from spring 66, while spring 66 pushes flanged washers 54 and 56 toward the open position;

flanged washers 54 and 56 slide inside sleeve 68, while spring 66 pushes them apart until flange shoulders 84 and 86 make contact with cylindrical washer 94 at contact point 82 and sensor housing 50 at contact point 88, respectively, thereby creating a short circuit and triggering the alarm; and

insulating washers 62 and 64 insulate bolt 80 from metal parts in contact with sensor housing 50; and

once the bolt is tightened, loosening the bolt 80 results in a short circuit which causes a change in resistance and an alarm.

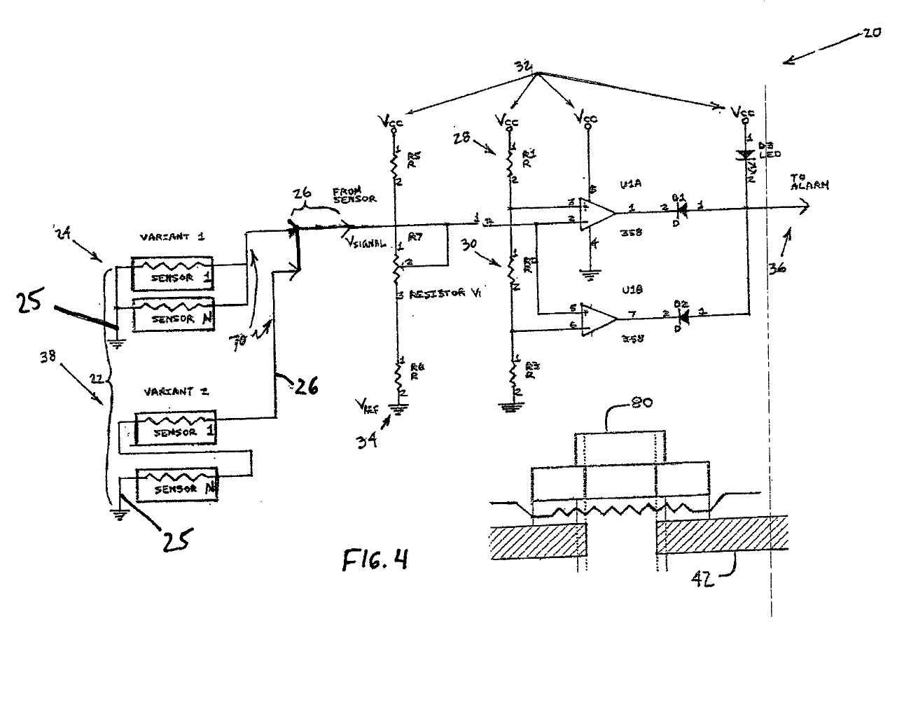

Reference is now made to FIG. 4, which illustrates a comparator circuit 20, in accordance with an exemplary embodiment of the present invention. In one exemplary variation a sensor electrical component 22 is comprised of a group of sensors, sensor 1 through sensor N, connected in parallel 24, with a combined constant resistance 70 equal to R. Sensor 22 is, in turn, connected by conductor 26 to comparator circuit 20. A comparator is defined as a control system that continuously monitors the value of a quantity, that quantity here being the resistance, in relation to the expected value.

In the most common configuration, comparator circuits 20 are implemented with positive feedback, with resistor R1 28 and resistor R2 30 providing hysteresis. In electronics, hysteresis connotes a double-valued function, in which different values are obtained depending on whether the independent variable, i.e., the resistance, increases or decreases. The amount of hysteresis affects the input/output relationship of comparator 20. Also, signals and noise always coexist in analog relationships. Increased hysteresis prevents comparator 20 output from “ringing” when an analog signal with superimposed noise approaches the comparison level.

A common design goal is to provide a hysteresis large enough to prevent a spurious alarm, while simultaneously keeping it low enough to achieve maximum sensitivity. The threshold values derived from Vcc 32 and Vref 34 are:

V_{TH+}=R1×(V_{CC}−V_{REF})/(R1+R2)(upper threshold)

and

V_{TH+}=R1×V_{REF}/(R1+R2)(lower threshold).

Thus, any change in the value of resistance 70 of sensor 22 beyond the threshold values, especially in the extreme cases of a short-circuit or a broken circuit, causes imbalance in comparator circuit 20, and triggers an alarm signal 36.

Interconnecting via conductor 26 a number of sensors 22, in parallel 24, or in series 38 to comparator 20, and balancing the circuit, results in a system in which there is no way of shorting or disconnecting any sensor 22 without triggering alarm 36. All interconnecting wires are “hotwires.” For either configuration the combined equivalent resistance 70 is R.

I claim:

1. An electromechanical sensor body for use with an alarm system, comprising:
an outer housing, said housing containing upper and lower conductive components, said upper and lower conductive components being elastically separated from one another and being compressibly displaceable from a first closed circuit position to a second open circuit position, said upper and lower conductive components being electrically isolated from said housing by at least one non-conducting sleeve when said conductive components are compressed into said second open circuit position and at least one of said upper and lower conductive components coming into conductive contact with said housing when said conductive components are in said first closed circuit position.

2. A sensor body in accordance with claim 1, wherein said conductive components are adapted to receive a bolt therethrough and wherein tightening said bolt displaces said upper and lower conductive components by compression.

3. A sensor body in accordance with claim 1, wherein at least one of said upper and lower conductive components are flanged washers.

4. A sensor body in accordance with claim 1, wherein at least one of said conductive components comprises two washers having different diameters.

5. A sensor body in accordance with claim 1, wherein said housing is connected to one lead of a comparator circuit and at least one of said conductive components is connected to another lead of said comparator circuit.

6. A sensor body in accordance with claim 1, wherein said conductive components are separated by a conductive compressible element.

7. A sensor body in accordance with claim 6, wherein said conductive compressible element is a metallic spring.
